(19) United States
(12) Patent Application Publication
(10) Pub. No.: US 2008/0030864 A1
(43) Pub. Date: Feb. 7, 2008

(54) Lenticular carrying case

(76) Inventors: Pierre Gougeon, Lachenaie (CA); Gerry Bonneau, Terrebonne (CA)

Correspondence Address: OGILVY RENAULT LLP, 1981 MCGILL COLLEGE AVENUE, SUITE 1600, MONTREAL, QC, H3A2Y3, US

(21) Appl. No.: 11/498,162

(22) Filed: Aug. 3, 2006

(51) Int. Cl. B65D 85/30; G02B 27/10; B65D 85/57

(52) U.S. Cl. 359/619; 206/308.1

(57) ABSTRACT

According to an embodiment of the present invention, there is provided a lenticular carrying case for carrying a disk, the lenticular carrying case comprising a single lenticular sheet having an exterior side, an interior side, parallel longitudinal lenses arranged in a given direction on the exterior side, and the single lenticular sheet for folding along a folding axis; and a disk carrying device for mounting onto the interior side of the single lenticular sheet and for carrying a disk.

### BACKGROUND OF THE INVENTION

1) Field of the Invention

The present invention relates to image displays; storage, carrying or holding devices; and lenticular lens technologies.

2) Description of the Prior Art

The various use and manufacturing methods related to lenticular sheet devices have previously been investigated. Processes for the preparation of articles having lenticular surfaces are known in the art. For example, it is possible to laminate an image sheet coated with a layer of radiation curable adhesive to a lenticular array sheet. Some have created various cards for use as telephone authorization or the like characterized by a layer of a backing material such as a stiff and thick layer of material like plastic with a rather limited pliability. Color dynamic, 3D flexible film has also been developed by printing an image on the opposite or interior surface of a transparent sheet having a lenticulated outer exterior surface.

The manufacturing value of products incorporating lenticular technologies is proven. New products in this field are therefore desirable.

### SUMMARY OF THE INVENTION

According to an embodiment of the present invention, there is provided a lenticular carrying case for carrying a disk, the lenticular carrying case comprising a single lenticular sheet having an exterior side, an interior side, parallel longitudinal lenses arranged in a given direction on the exterior side, and the single lenticular sheet for folding along a folding axis; and a disk carrying device for mounting onto the interior side of the single lenticular sheet and for carrying a disk.

According to another embodiment of the present invention, there is provided a lenticular carrying case for carrying an article, the lenticular carrying case comprising: an exterior face; a lenticular sheet having an exterior side, an interior side, and parallel longitudinal lenses on the exterior side, said lenticular sheet comprising an exterior image for displaying a special-effect, said exterior image being visible from said exterior side which corresponds to at least a portion of the exterior face; and a carrying device for mounting onto the interior side of the lenticular sheet and for carrying an article.

According to yet another embodiment of the present invention, there is provided a lenticular carrying case for carrying an article, the lenticular carrying case comprising a lenticular sheet having an exterior side, an interior side, parallel longitudinal lenses on the exterior side, and a folding area, the lenticular sheet for folding within the folding area, to create a pocket for carrying an article.

In this specification, the following terms are used with the following definition unless otherwise described.

The term “transparent” refers to clear, semi-transparent, translucent, or other adjectives describing a compound layer that would hence permit the ability of transmitting light or radiation across the entirety of the layer.

“Carrying case” refers to all holding devices, trays, jewel cases, boxes, racks, storage devices and the like, used for carrying anything from disks (CD, DVD and the like), books, cards and papers, for example.

### BRIEF DESCRIPTION OF THE DRAWINGS

Further features and advantages of the present invention will become apparent from the following detailed description, taken in combination with the appended drawings, in which:

FIG. 1a is a perspective view of a folded lenticular sheet according to a first embodiment wherein the entire device is a carrying case for carrying three disks, shown in a semi-opened position;

FIG. 1b is a perspective view of a folded lenticular sheet according to a second embodiment wherein the entire device is a carrying case having the possibility of carrying two disks, and is shown in a semi-opened position;

FIG. 2 is a top view of the carrying case as shown in FIG. 1a, wherein the dotted lines represent the disk carrying devices positioned under the lenticular sheet;

FIG. 3 is a partial cut-out view showing the structure of the lenticular sheet according to one possible embodiment;

FIG. 4 is a partial cut-out view showing the structure of the lenticular sheet according to another embodiment;

FIG. 5 is a close-up view showing the parallel longitudinal lenses of the lenticular sheet, with the perforations performed at the folding lines of the lenticular sheet; and

FIG. 6 illustrates the carrying case of FIG. 1a in a closed position.

It will be noted that throughout the appended drawings, like features are identified by like reference numerals.

### DETAILED DESCRIPTION

The embodiments of the invention described above are intended to be exemplary only. The scope of the invention is therefore intended to be limited solely by the scope of the appended claims.

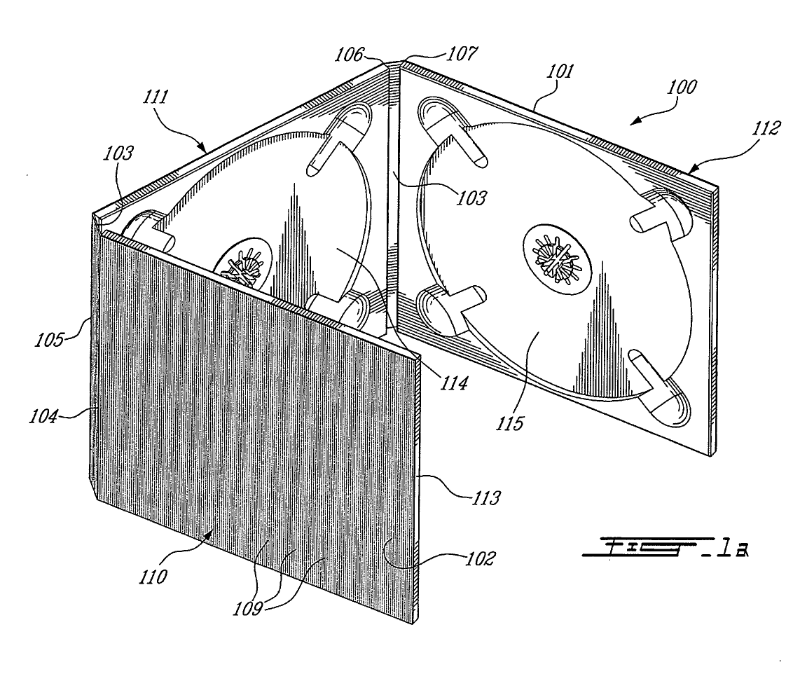

Referring to FIG. 1a, the carrying case 100 is made of one single lenticular sheet 101 shaped in a substantially rectangular fashion, and thereby having four edges. The lenticular sheet 101 further comprises an exterior side 102 and an interior side 103, and is folded on four folding lines 104-107. All folding lines 104-107 follow a given folding axis (not shown) that is parallel to the given direction of the parallel longitudinal lenses 109 located next to each other on the exterior side 103 of the lenticular sheet 101. The parallel longitudinal lenses can take any given direction with respect to the folding axis, or folding lines 104-108, or 118-119. In the illustrated embodiment, however, the direction of the parallel longitudinal lenses 109 is parallel to the folding axis, or folding lines 104-108, or 118-119. Moreover, the parallel longitudinal lenses 109 are in a direction that extends from one edge of the lenticular sheet to an opposite edge, either vertically (as represented) or horizontally (not shown). Folding the lenticular sheet 101 on the four folding lines 104-107, or on a weakness which permits the folding of the lenticular sheet 101 along a folding axis (not shown) and within a folding area (not shown), forms a pamphlet-like structure as shown in FIG. 1a. This pamphlet-like structure is herein composed of three pages or leaflets 110, 111 and 112; page 111 being the middle page, and pages 110 and 112 referred to as the external pages. At least one of pages 110, 111 and 112 has mounted upon its interior side a tray ora disk carrying device 113, 114 or 115, having a substantially square or rectangular shape with four corners. In the illustrated embodiment, the disk carrying devices 113, 114 or 115 are each mounted on one of the three pages 110, 111 and 112 of the carrying case 100. The number of disk carrying devices is set as desired. The completely folded and closed carrying case 100, has one of its external pages, page 110 or 112, folded inwardly such that the second external page, 112 or 110 respectively, becomes the cover page of the carrying case 100.

A second embodiment illustrated in FIG. 1b, shows the carrying case now reduced to only two pages 116 and 117. In such an embodiment, the lenticular sheet 101 is folded on two consecutive folding lines 118-119, also referred to as weaknesses in the lenticular sheet 101. The folding lines 118-119, or folding weaknesses, are located along a folding axis (not shown) and within a folding area (not shown). In the illustrated case, these folding lines 118-119, or weaknesses, are further located at only one vertical edge of the carrying case 100. A maximum of two disk carrying devices 120 and 121 can thus be mounted inside the carrying case 100, or one the interior side of the lenticular sheet 101; one on each of the two pages 116 and 117. The exterior face 122 is here defined as the exterior side of pages 116 and 117. Other embodiments incorporating a greater number of pages are also possible.

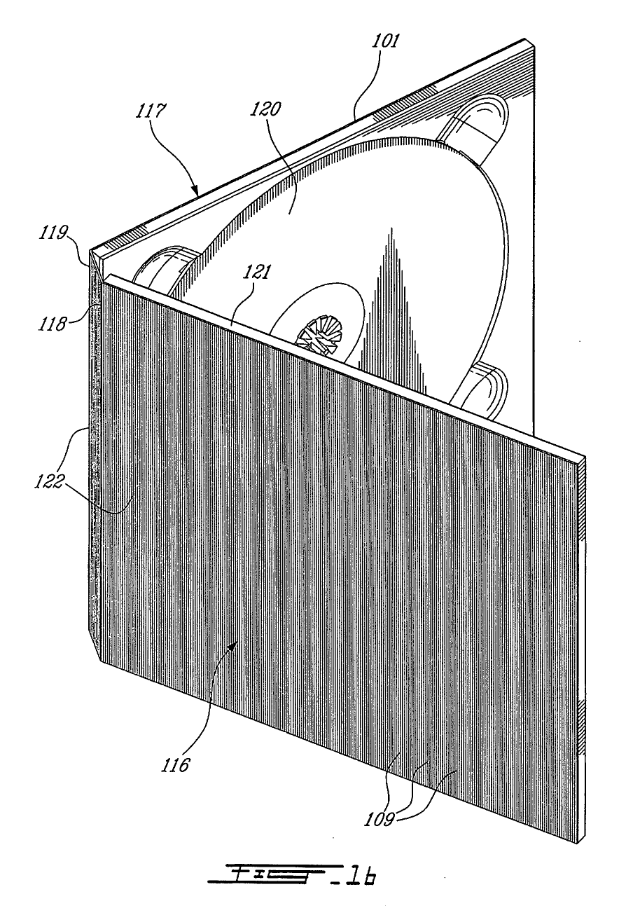

Referring to FIG. 2, a disk carrying device (one of 113 to 115, or 120 to 121), is mounted onto the interior side of a page (one of pages 110 to 112, or 116 to 117), and held onto the page using adhesive areas. As an example, FIG. 2 shows four particular areas represented by areas 201, 202, 203 and 204, located substantially near each of the four corners of the substantially square-shaped or rectangular-shaped disk carrying device (one of 113 to 115, or 120 to 121). These areas 201-204 are for coming into contact with an adhesive means and form any given shape, such as a line or a spot. The adhesive means are based on any of synthetic, drying, hot, reactive and pressure adhesion principles. The adhesive means are, for example, based on elastomers, epoxy, glues, rubber and contact cements; adhesive tapes, UV curable adhesive material, and moisture cure adhesives. Alternatively, a disk carrying device can also be mounted onto the interior side of a page using any means for attaching that are based on other techniques not requiring adhesive means, such as providing attachment folds, clips, rivets or grooves.

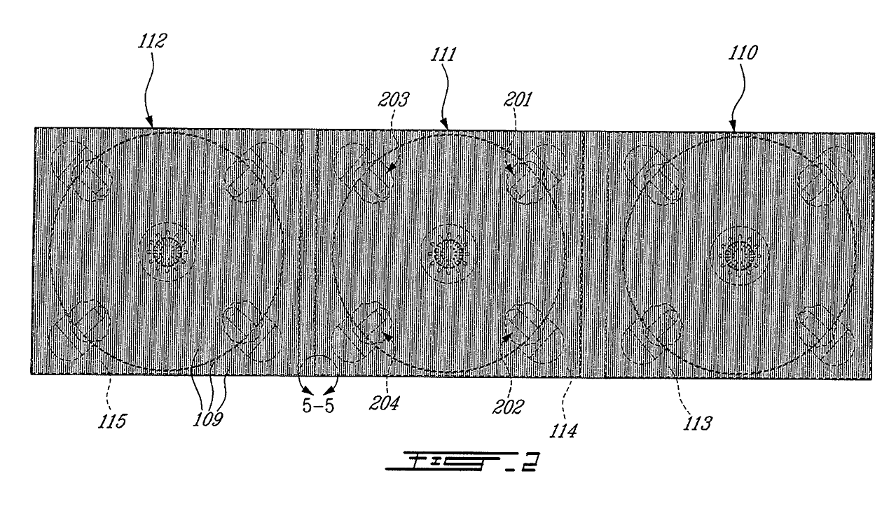

Referring to FIG. 3, the lenticular sheet 101 again having an exterior side 102 and an interior side 103. Starting from the exterior side 102 and going towards the interior side 103, the lenticular sheet 101 is composed of a first transparent lenticular layer 303, having a lenticular-shaped surface forming the exterior side 102 of the lenticular sheet 101, and a smooth surface on the other side. The lenticular-shaped surface is characterized by parallel longitudinal lenses 109 placed next to each other and extending the entire surface of the lenticular sheet 101. The lenticular layer 303 has an image printed upon its interior smooth side using four ink layers 306, or commonly named four-color process, wherein four ink colors (the three primary colors, cyan magenta yellow, and black) are applied to form the cover image of the lenticular sheet 101. These four ink layers 306 thus form a special-effect on the exterior image, which is visible from the exterior side 102 of the lenticular sheet 101. The special-effect is apparent upon changing a viewer's perspective in a direction that is perpendicular to the parallel longitudinal lenses 109. In other words, the special-effect is for appearing to a viewer upon a perpendicular displacement of said viewer's position with respect to said parallel longitudinal lenses. The last ink layer of 306 is then coated with a coating layer 307, onto which a sheet of white polypropylene 308 is applied. The coating layer 307 may either be a water base if the inks employed for the four ink layers 306 are conventional inks, or a lacquer if the four ink layers 306 are UV inks. The other side of this white polypropylene sheet 308 is then color processed again using a four-color process or ink layers 309. The four ink layers 309 thus form the image visible from the interior side 103 of the lenticular sheet 101. The last ink layer of 309 is also covered with another coating layer 310, again either a water base or a lacquer, to protect the ink layers and reduce ink transfers that may occur during fabrication and handling.

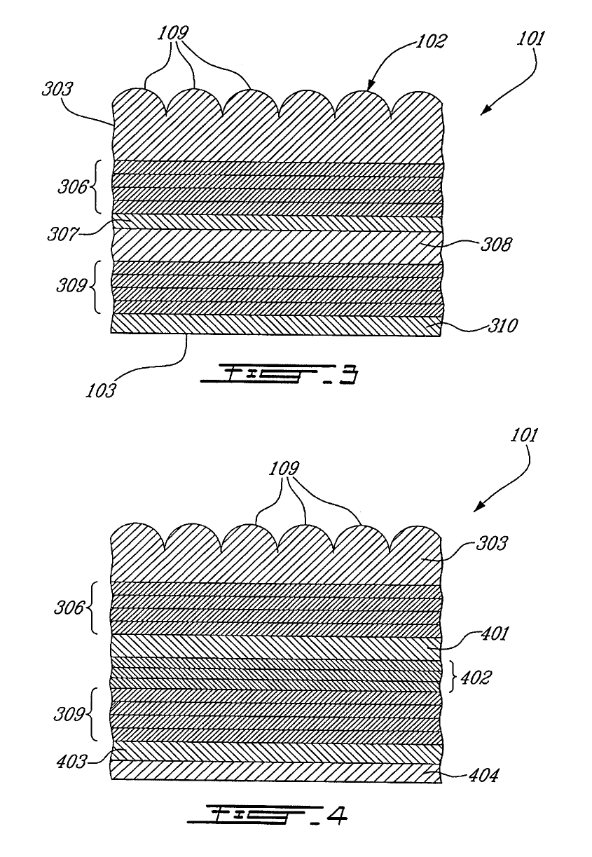

Referring to FIG. 4 and according to a second embodiment, the lenticular sheet 101 has a structure comprised of a transparent lenticular layer 303, having on one side a lenticular-shaped surface, characterized as described above, and a smooth surface on the other side. The lenticular layer 303 has an image printed upon its interior smooth side using again a four-color process or ink layers 306 to form the three-dimensional image visible from the exterior side 102 of the lenticular sheet 101. The last ink layer of 306 is then coated with a coating layer 401, again either a lacquer or a water base, onto which three layers of white paint 402 are pressed to form an opaque layer for separating the image visible from the exterior side 102 and the image visible from the interior side 103. The layer of white paint 402 can be replaced by any opaque layer such as opaque vinyl, polyester or any other agent that provides for opacity and creates a separation; layers of grey paint is one example. The image visible from the interior side 103 of the lenticular sheet 101 is then printed on top of the last layer of white paint layers 402 again using a four-color process or ink layers 309, once again finished with a second coating layer 403. The entire structure is then covered with a transparent polypropylene layer 404 such that the Image is visible from the interior side 103 of the lenticular sheet 101.

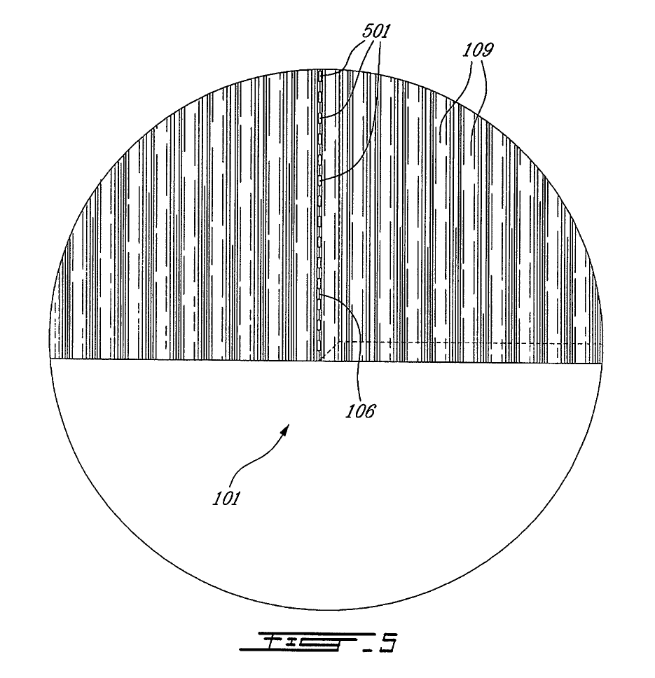

Referring to FIG. 5, the folding of the lenticular sheet 101 is performed by directly bending the lenticular sheet 101 on the folding line 106. In the illustrated embodiment shown in FIG. 5, perforations 501 are performed at the folding line 106 in order to facilitate the bending of the lenticular sheet 101.

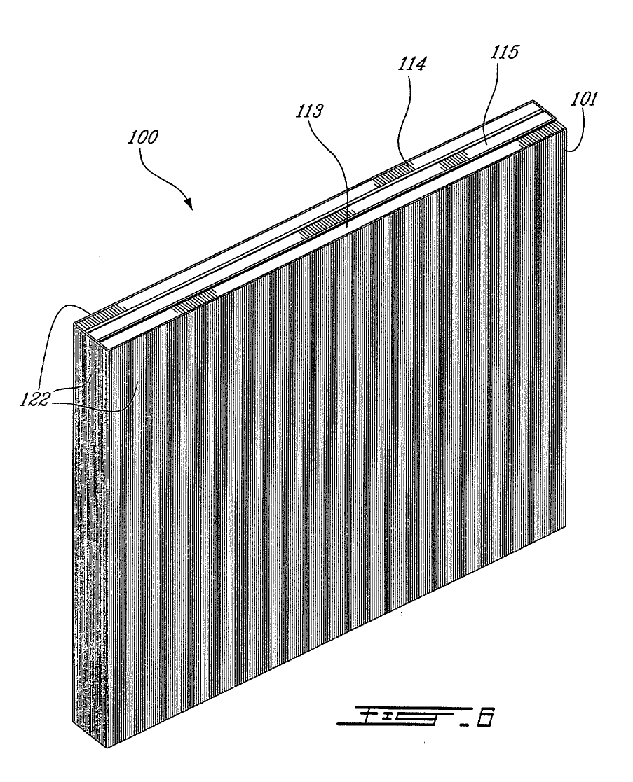

Finally, the completed and closed lenticular carrying case 100 of FIG. 1a is shown in FIG. 6. The exterior face 122 is further illustrated by the portions of the lenticular carrying case 100 that are visible from the exterior once the case is closed.

The transparent lenticular layer 303, as illustrated in FIGS. 3 or 4, is made of a transparent plastic or polymer such as Polyvinyl Chloride (PVC), acrylic, Polymethyl Methacrylate (PMMA), silicones, or polysiloxanes (like Polydimethylsiloxane, referred to as PDMS), polyurethane, polyester or co-polyester such as Polyethylene Terephthalates (either Amorphous (APET) or Glycolised (GPET)), and laminated vinyl. The white polypropylene layer 308 (of FIG. 3) and the transparent polypropylene layer 404 (of FIG. 4) are used such that the lenticular sheet 101 has a more resistant structure. Hence, the white polypropylene layer 308 (of FIG. 3) and of the transparent polypropylene layer 404 (of FIG. 4) are more generally referred to as a strengthening layer. Other materials can provide for the lenticular sheet's greater resistance or strength provided herein, such as acrylic, polyester-based materials, cardboard and paper. For example, since transparency is not essential in the embodiment illustrated by FIG. 3, the white polypropylene layer 308 can be replaced by either paper or cardboard. The transparent polypropylene layer 404 illustrated in FIG. 4, can also be replaced by another strengthening material provided the material in question is transparent.

It is understood that the above described specific embodiment can be further generalized to a single lenticular sheet 101 (such as the one shown in FIGS. 1a, 1b, 3, 4, 5 and 6) of any other given shape, substantially rectangular or not. The lenticular sheet can take, for example, the shape of an L, a U, an H, or a T. The lenticular sheet 101 of a given shape comprises a folding area or multiple folding areas (not shown) for folding the lenticular sheet 101 on a folding axis (not shown), the folding axis being in any given direction. The lenticular sheet 101 of this embodiment is folded anywhere within the folding area and further comprise adhesive means. Such an embodiment permits the creation of a pocket made with the lenticular sheet 101 which is useful for carrying a variety of devices or articles like pages of a book, greeting cards or letters, disks, keys and memory sticks. Further applications of a single folded lenticular sheet comprise, for example, lenticular greeting cards, envelopes, book covers, boxes, carrying and storage means.

Referring to the same elements introduced by FIGS. 1a and 1b, where these elements are taken separately, another embodiment of a lenticular carrying case 100 for carrying any article herein comprises an exterior face; a lenticular sheet 101 having an exterior side 102, an interior side 103, and parallel longitudinal lenses 109 on the exterior side, the lenticular sheet 101 comprising an exterior image for displaying a special-effect, the exterior image being visible from the exterior side 102 of the single lenticular sheet 101 which corresponds to the exterior face; and a carrying device for mounting onto said interior side 103 of said lenticular sheet 101 and for carrying said article.

In yet another embodiment of a lenticular carrying case 100 for carrying an article, the lenticular carrying case 100 comprises a lenticular sheet 101 having an exterior side 102, an interior side 103, parallel longitudinal lenses 109 on the exterior side 102, and a folding area, the lenticular sheet being for folding within the folding area, in order to create a pocket for carrying an article.

What is claimed is:

1. A lenticular carrying case for carrying a disk, said lenticular carrying case comprising:
a single lenticular sheet having an exterior side, an interior side, parallel longitudinal lenses arranged in a given direction on said exterior side, said single lenticular sheet for folding along a folding axis; and
at least one disk carrying device for mounting onto said interior side of said single lenticular sheet and for carrying said disk.

2. The lenticular carrying case as in claim 1, wherein said folding axis comprises a folding axis parallel to said given direction.

3. The lenticular carrying case as in claim 1, wherein said folding axis comprises a folding axis perpendicular to said given direction.

4. The lenticular carrying case as in claim 1, wherein said lenticular sheet further comprises a folding area for folding said lenticular sheet within said folding area.

5. The lenticular carrying case as in claim 1, wherein said single lenticular sheet when folded along said folding axis, creates at least two pages.

6. The lenticular carrying case as in claim 5, wherein said disk carrying device comprises at least two disk carrying devices, each one of the at least two disk carrying devices for mounting on each of said at least two pages.

7. The lenticular carrying case as in claim 1, wherein said single lenticular sheet comprises perforations along said folding axis to facilitate folding.

8. The lenticular carrying case as in claim 1, further comprising means for attaching said disk carrying device to said interior side of said single lenticular sheet.

9. The lenticular carrying case as in claim 8, wherein said means for attaching comprises adhesive means.

10. The lenticular carrying case as in claim 9, wherein said adhesive means comprises at least one of: hot glue, elastomers, epoxy, contact cement, rubber cement, adhesive tape, UV curable adhesive material, and moisture cure adhesives.

11. The lenticular carrying case as in claim 9, wherein the disk carrying device further comprises areas for coming in contact with said adhesive means.

12. The lenticular carrying case as in claim 11, wherein said disk carrying device has at least one of a substantially square shape and a substantially rectangular shape, each having four corners.

13. The lenticular carrying case as in claim 12, further wherein said areas are located substantially near the four corners of said square disk carrying device.

14. The lenticular carrying case as in claim 1, wherein said single lenticular sheet comprises a strengthening layer of material having a given thickness.

15. The lenticular carrying case as in claim 14, wherein said strengthening layer of material comprises at least one of: a layer of polypropylene, a layer of acrylic, a layer of a polyester based material, a layer of paper and a layer of cardboard.

16. The lenticular carrying case as in claim 14, wherein said given thickness comprises a thickness smaller or equal to 0.0030 inches.

17. The lenticular carrying case as in claim 1, wherein said single lenticular sheet comprises an exterior image for displaying a special-effect, said exterior image being visible from said exterior side of said single lenticular sheet.

18. The lenticular carrying case as in claim 17, wherein said special-effect for appearing to a viewer upon a perpendicular displacement of said viewer's position with respect to said parallel longitudinal lenses.

19. The lenticular carrying case as in claim 17, wherein said single lenticular sheet further comprises an interior image visible from said interior side of said single lenticular sheet.

20. The lenticular carrying case as in claim 1, wherein said parallel longitudinal lenses of said single lenticular sheet are composed of a transparent polymer compound.

21. The lenticular carrying case as in claim 20, wherein said transparent polymer compound comprises at least one of Polyvinyl Chloride (PVC), Amorphous Polyethylene Terephthalates (APET), Glycolised Polyethylene Terephthalates (GPET), acrylic, PP plastic, PS plastic, vinyl, and polycarbonate.

22. The lenticular carrying case as in claim 1, wherein said single lenticular sheet has a substantially rectangular shape having four edges.

23. The lenticular carrying case as in claim 22, further wherein said given direction goes from a first one of said four edges to a second one of said four edges, said first one of said four edges and said second one of said four edges being located opposite from each other, and said given direction being perpendicular to at least one of said four edges.

24. A lenticular carrying case for carrying an article, said lenticular carrying case comprising:
an exterior face;
a lenticular sheet having an exterior side, an interior side, and parallel longitudinal lenses on said exterior side, said lenticular sheet comprising an exterior image for displaying a special-effect, said exterior image being visible from said exterior side which corresponds to at least a portion of the exterior face; and
a carrying device for mounting onto said interior side of said lenticular sheet and for carrying said article.

25. The lenticular carrying case as in claim 24, wherein said lenticular sheet further comprises a folding area for folding said lenticular sheet within said folding area.

26. A lenticular carrying case for carrying an article, said lenticular carrying case comprising:
a lenticular sheet having an exterior side, an interior side, parallel longitudinal lenses on said exterior side, and a folding area, said lenticular sheet for folding within said folding area, to create a pocket for carrying said article.

27. The lenticular carrying case as in claim 26, wherein said lenticular carrying case further comprises adhesive means for applying to said lenticular sheet to contribute in keeping said lenticular sheet folded and thereby create said pocket.
